(19) United States
(12) Patent Application Publication
(10) Pub. No.: US 2012/0057734 A1
(43) Pub. Date: Mar. 8, 2012

(54) Hearing Device System and Method

(75) Inventors: Stephen D. Ambrose, Longmont, CO (US); Samuel P. Gido, Hadley, MA (US); Robert B. Schulein, Schaumburg, IL (US)

(73) Assignee: Asius Technologies, LLC, Beaverton, OR (US)

(21) Appl. No.: 13/222,943

(22) Filed: Aug. 31, 2011

Related U.S. Application Data
(63) Continuation-in-part of application No. 12/178,236, filed on Jul. 23, 2008.
Application No. 12/178,236 is a continuation-in-part of application No. 12/777,001, filed on May 10, 2010.
Application No. 12/777,001 is a continuation-in-part of application No. 13/086,138, filed on Apr. 13, 2011.
(60) Provisional application No. 61/378,695, filed on Aug. 31, 2010.

(51) Int. Cl. H04R 25/00

(52) U.S. Cl. 381/328

(57) ABSTRACT

A system for linking together audio signal producing, signal processing, and ear coupling devices comprising, in an embodiment: (1) an in-ear audio coupling device; (2) hearing aid electronics; (3) an external audio signal generating device; and (4) a module for audio mixing and enhancement.

### CROSS-REFERENCE TO RELATED APPLICATIONS

This application claims the benefit of U.S. Provisional Patent Application Ser. No. 61/378,695 filed on Aug. 31, 2010, and herein incorporated by reference.

This application is also a continuation-in-part, and thus claims priority to: U.S. Utility patent application Ser. No. 12/178,236, filed Jul. 23, 2008; U.S. Utility patent application Ser. No. 12/777,001, filed May 10, 2010; and, U.S. Utility patent application Ser. No. 13/086,138, filed Apr. 13, 2011, all of which are incorporated herein by reference and may also be referred to herein, collectively or individually, as “the incorporated references.”

### TECHNICAL FIELD OF THE INVENTION

The present invention relates to sound reproduction fidelity and comfort associated with a hearing aid designed for insertion into an ear canal, in which at least a portion of the hearing aid is exposed to the outside world.

### BACKGROUND OF THE INVENTION

As the primary purpose of a hearing aid is that of improving speech communication, compromises are generally made regarding the ability of the device to reproduce high fidelity sound in terms of frequency response, dynamic range and spatial accuracy. Such compromises are due to factors such as size, required battery capacity, and the signal performance capabilities of the digital signal processor used. These compromises are typically independent of the type and means of acoustically coupling sound into an ear canal.

Sound coupled by means of sealing a receiver into an ear canal with a very small acoustical leak, has been shown to be of very high quality, particularly with respect to low frequency reproduction. In addition a seal established by means of an ADEL type inflatable membrane has been shown to further enhance such fidelity with the addition of long term comfort and a low occlusion effect. Given these factors, a need is seen for connecting higher quality audio signals to the receiver portion of such hearing aids, for those individuals desiring higher quality audio such as when experiencing audio and video entertainment in live and recorded venues.

It is envisioned by the inventors that the distinction between in-ear hearing aid devices and in-ear sound producing devices for communications and entertainment will lessen and may disappear. This produces a number of advantages for the user. Firstly, people with hearing loss, like everyone else, need to use telephones and other audio communications and may enjoy listening to music or other audio programming. It would be convenient and cost effective for these users to have a single in-ear audio coupling that can be used not only with a hearing aid but also with a range of other devices, such as a cell phone, a smart phone, an MP3 player, or a device such as the iPhone that encompasses all these functions.

Secondly, the perceived stigma of appearing handicapped keeps a significant percentage of people who would benefit from a hearing aid from wearing one. One embodiment described in this disclosure is an in-ear audio coupling connected to a smart phone or similar device. The smart phone has a microphone as well as software, which could be a downloadable application or “app” that allows it to pick up ambient sound, process and amplify it and transmit it to the in-ear audio coupling. Thus the combination of the smart phone and its software with the in-ear audio coupling can perform the function of a hearing aid. At the same time this combination also can function as a telephone and as a music/audio program player. A smart phone or MP3 player on the hip makes a person appear anything but handicapped. Such devices are typically signs of success, youth, vigor, etc. However, this electronic device on the hip can also double as a hearing aid, through the connection to an in-ear audio coupling.

Thirdly, conventional hearing aids, fitted by an audiologist, are very expensive, costing thousands of dollars per ear. This is an additional deterrent that keeps many with hearing loss from seeking help. The inventors disclose herein an approach to hearing aids in which a relatively inexpensive in-ear audio coupling is connected directly to an external electronic device such as a smart phone. A software application for the smart phone may be downloaded, and when installed, allows the microphone and signal processing capabilities of the smart phone to supply the in-ear audio coupling with amplified ambient sound, thus functioning as a hearing aid. This approach would be significantly less expensive than conventional hearing aids, and the software application can even allow the user to adjust the audio response of the hearing aid to fit their own particular profile of hearing loss across the sound frequency spectrum.

### SUMMARY OF THE INVENTION

In an embodiment, the present invention pertains to systems for linking together audio signal producing, signal processing, and ear coupling devices in novel arrangements. The components to be linked together include: (1) an in-ear audio coupling device; (2) hearing aid electronics; (3) an external audio signal generating device; and (4) a module for audio mixing and enhancement.

The in-ear audio coupling device is a means to direct sound into the ear canal while isolating this sound source from any microphones and amplification electronics which could lead to feedback. Such in-ear audio coupling devices therefore often utilize an “acoustic seal” which is created by a snug fitting piece inserted into the ear. Examples of such in-ear audio coupling devices include custom ear molds of the type used in hearing aids and in stage monitors for professional musicians. Custom ear molds are produced by taking an imprint of the inside of the wearer's ear canal and fabricating a device to fit and seal to that exact shape. The Ambrose Diaphonic Ear Lens (ADEL™) described in previous patents by Asius Technologies (i.e., the incorporated references) is another example of an in-ear coupling device which directs sound into the ear canal and which produces an acoustic seal.

In-ear coupling audio devices of the type described in the preceding paragraph can use a sound generating receiver (moving coil speaker or balanced armature transducer or the like) which is located in the ear canal, along with the ear mold or ADEL bubble that is producing the acoustic seal. This configuration is known as Receiver in Canal (RIC). It is also possible to have in-ear audio coupling devices in which the sound generating receiver is located outside of the ear canal and the sound is directed through the acoustic seal and into the ear canal via a sound tube. This external receiver configuration is available both with custom ear molds and with the ADEL inflatable ear coupling.

Finally, in-ear audio coupling devices also exist in which the ear canal is not physically closed off to produce an acoustical seal. In these “open architecture” devices feedback is controlled electronically. All of the types of in-ear audio coupling devices described above may be a component in the inventive device configurations disclosed herein.

The second component is “hearing aid electronics.” This comprises electronic hardware as well as software built into a hearing aid, which detects ambient sound (microphone), amplifies this sound, may perform other signal processing, and may also suppress feedback. In conventional, commercial hearing aids, these hearing aid electronics may be housed within the ear mold, may protrude from the ear, may be in a module located behind the ear, or may be in a package worn on the body.

The third component is an “audio signal generating device.” This can be any of a wide range of electronic devices including an MP3 player, a cell phone, a wired telephone, a smart phone, a radio receiver, a television audio output, audio output from another audio/video device, a computer, a communications device or a voice over IP signal from a computer.

The fourth component is a module of electronics and/or software for sound mixing and enhancement. This module may be a stand-alone device or it may exist as software or hardware, or both software and hardware, built into either the audio signal generating device or the hearing aid electronics. This module allows mixing of ambient sound (hearing aid function) with audio program material from the audio signal generating device, thus allowing the user to (for instance) listen to music while not being isolated from the outside world. This module also includes electronics and/or software to enhance the sound quality experienced by a hearing aid user and to increase their directional sound awareness.

Other embodiments, systems, methods, features and advantages of the present invention will be, or will become, apparent to one having ordinary skill in the art upon examination of the following drawings and detailed description. It is intended that all such additional systems, methods, features, and advantages included within this description be within the scope of the present invention, and be protected by the accompanying claims.

### BRIEF DESCRIPTION OF THE DRAWINGS

The invention may be better understood with reference to the following drawings. The components in the drawings may not be necessarily to scale, emphasis instead being placed upon illustrating the principles of the invention. In the drawings, like reference numerals designate corresponding parts throughout the several views.

FIG. 1 depicts a simple configuration in which an external audio signal generating device is connected to a hearing aid;

FIG. 2a depicts another approach to that depicted in FIG. 1;

FIG. 2b is an illustration of an embodiment of a system in accordance with FIG. 2a;

FIG. 3a depicts another connectivity in which the external audio signal generating device is plugged directly into the in-ear audio coupling without passing through the hearing aid body;

FIG. 3b depicts a detailed illustration of a system with the connectivity of FIG. 3a;

FIG. 4 depicts another approach in which the in-ear audio coupling has a universal jack on it which allows it to be connected to any of a number of external audio signal generating devices (FIG. 4a) as well as to a hearing aid body (FIG. 4b);

FIG. 5 depicts a configuration which blends ambient sound (hearing aid function) with the output of an external audio signal generating device;

FIG. 6 depicts a configuration in which the external signal generating device drives the in-ear audio coupling without input from the hearing aid electronics;

FIG. 7 depicts an evolution of FIG. 6 in which the hearing aid electronics are dropped;

FIG. 8 depicts an embodiment of a Life Studio in accordance with the present invention;

FIG. 9 depicts a design for pumping air using two balanced armature transducers with their front volume in fluid communication;

FIG. 10 depicts that, when one of the diaphragms of FIG. 9 moves towards its respective front volume, the other diaphragm is moving away from its front volume, and vice versa;

FIG. 11 depicts an embodiment in which the two diaphonic pumps (diaphonic valves) act in parallel;

FIG. 12 depicts a series arrangement of the two diaphonic pumps (diaphonic valves) for producing higher static air pressures;

FIG. 13 depicts an example of the embodiment of FIG. 11 in which the connection between the two front volumes is so large that these front volumes are essentially merged into one;

FIG. 14 depicts an example of the embodiment of FIG. 12 in which the two front volumes are essentially merged into one;

### DETAILED DESCRIPTION OF THE INVENTION

The following descriptions of detailed embodiments are for exemplifying the principles and advantages of the inventions claimed herein. They are not to be taken in any way as limitations on the scope of the inventions.

Connectivity

The components described in the sections above are connected together and communicate with one another in various configurations using either hard wired connections or using wireless connections, such as Bluetooth.

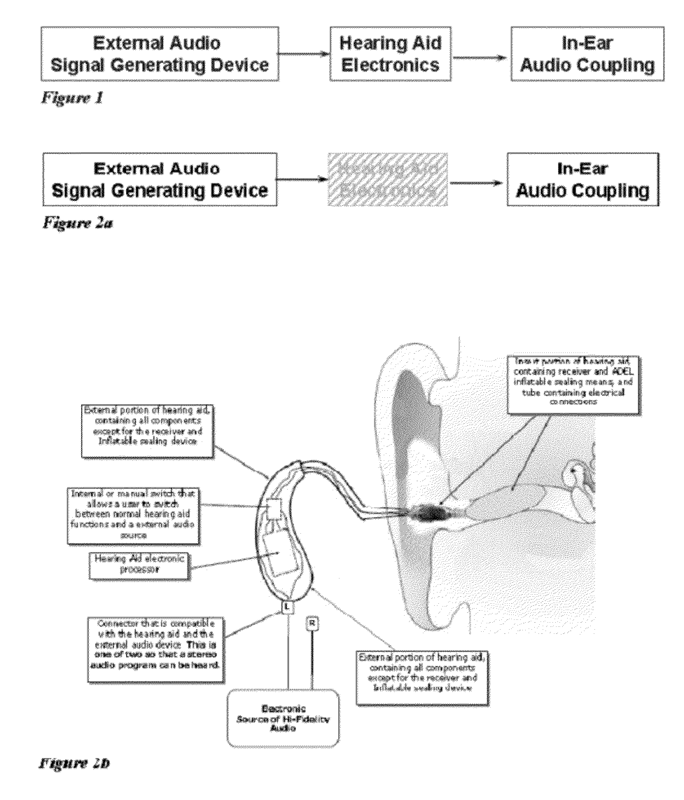

FIG. 1 shows a simple configuration in which an external audio signal generating device is connected to a hearing aid. The signal from the device is passed to the hearing aid electronics and then on to in in-ear audio coupling.

At least one example of this configuration is currently available commercially: A cell phone can pass its audio output signal directing to a hearing aid as a Bluetooth signal. The user then hears the phone signal directing through the hearing aid speaker and in-ear coupling.

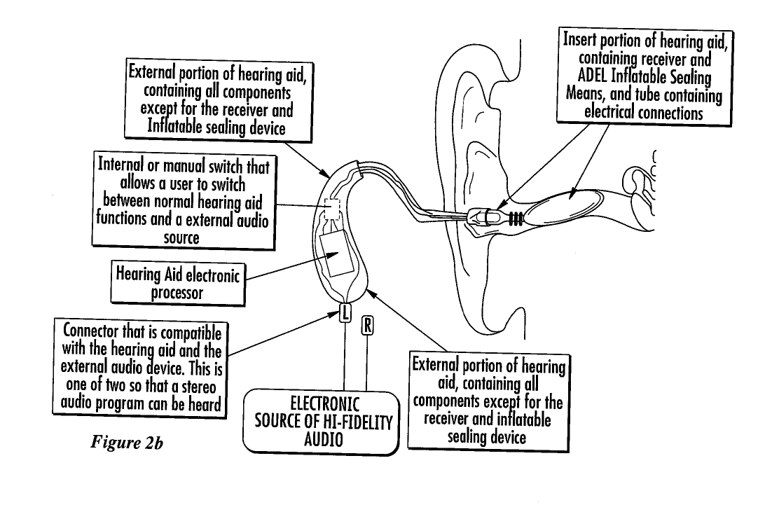

Here we disclose another approach as illustrated in FIG. 2a.

This embodiment is in the form of a feature, where by the hearing aid manufacture facilitates the switching by manual or automatic means. If manual the user would move a switch on the hearing aid body. If automatic the hearing aid would detect the presence of an external signal and then switch to that signal. An illustration of this system is shown in FIG. 2b. An external audio signal generating device such as a smart phone or a MP3 player is connected via a wired connection into the body of a hearing aid. The act of plugging a connector into the jack on the hearing aid body deactivates the hearing aid electronics and allows the signal from the external audio signal generating device to pass, unmodified directly to the in-ear audio coupling. The user can then adjust the amplification and otherwise adjust the signal to suit their hearing using the controls on the external audio signal generating device. In this configuration the external audio signal generating device performs both its own function of delivering audio and also the function of the hearing aid electronics.

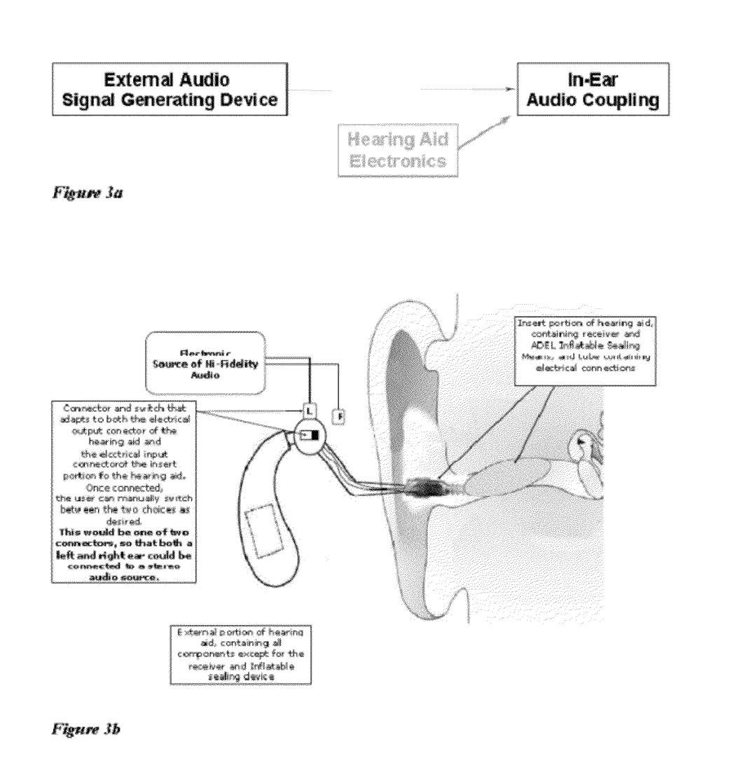

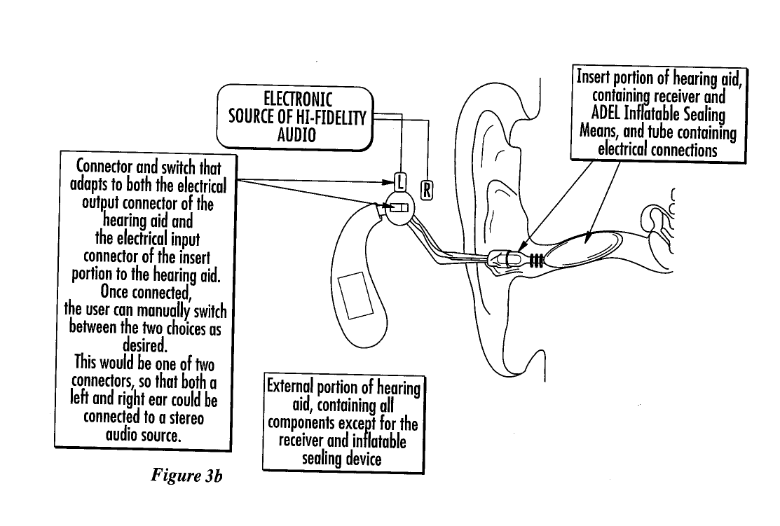

FIG. 3a discloses another connectivity in which the external audio signal generating device is plugged directly into the in-ear audio coupling without passing through the hearing aid body. As shown in the figure, the hearing aid body with its electronics and software, might still be present and might remain connected to the in-ear audio coupling. However, the external audio signal generating device takes over control of the in-ear audio coupling while it is plugged in. In this case the external audio signal generating device must perform all the amplification and signal processing necessary to produce a sound output through the in-ear audio coupling that the user can hear.

FIG. 3b shows a detailed illustration of a system with the connectivity of FIG. 3a, which allows insert portion of Hearing Aid to be switched between hearing aid audio signals and external high fidelity signal source. Connection and switch are made external from the hearing aid. This would allow for an after-market product.

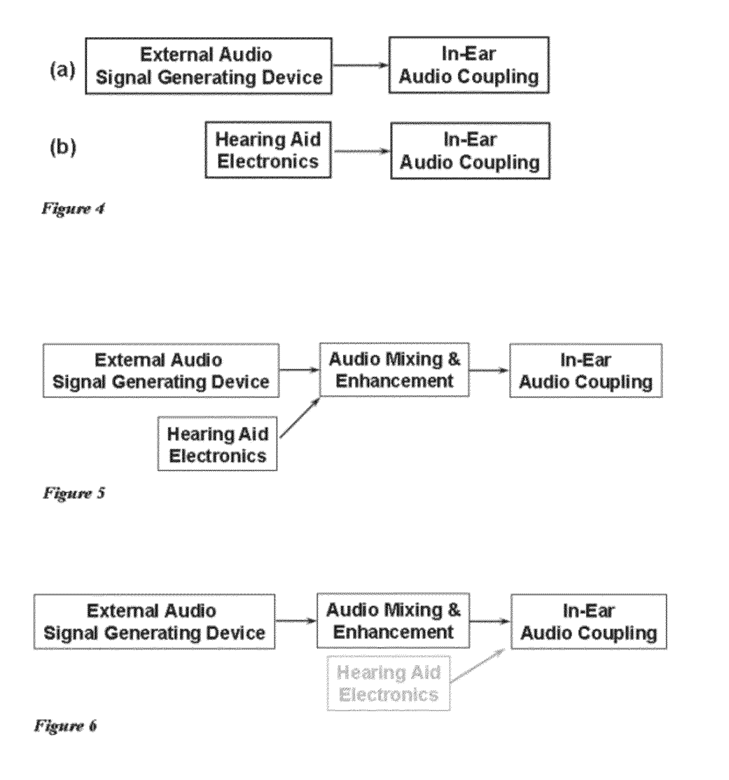

FIG. 4 shows another approach in which the in-ear audio coupling has a universal jack on it which allows it to be connected to any of a number of external audio signal generating devices (FIG. 4a) as well as to a hearing aid body (FIG. 4b). Thus the very same in-ear acoustical coupling can be used with a hearing aid or to connect directly to other devices.

FIG. 5 shows a configuration which blends ambient sound (hearing aid function) with the output of an external audio signal generating device. This can, for instance, allow a person to listen to music or the radio while still hearing enough of the outside world to maintain safety and situational awareness. This provides the listener with an experience which is much more like the “normal” experience of listening to audio transmitted through the air with open ears than is either the experience of listing to music with ear buds or listening to the world through a hearing aid.

The module that mixes ambient sound from the hearing aid with the audio program material is an application developed by Asius called “Life Studio.” Life Studio, can be used with audio headphones for the interactive enjoyment of music and other audio, as described in the next section of this disclosure. Here Life Studio features are discussed in the context of hearing aids. Life Studio may be implemented with electronics or as software running on another electronic device such as a smart phone or computer. In addition to mixing ambient sound with other audio feeds, Life Studio can improve the sound quality and spatial awareness experience by the user. In-ear audio coupling devices as used in hearing aids and insert headphones can sound cramped. They lack the reverberation effects of listening to sound in natural spaces such as rooms or the outdoors, can make in-ear speakers sound unnatural. The mixing and signal processing module and Life Studio allow a small amount of “reverb” to be used to produce a more natural sounding experience.

Life Studio signal processing can be used with binaural microphones to give the hearing aid listener a more open and natural sounding experience and enhanced ability (over conventional hearing aids) to sense the direction of sounds in their environment. This is achieved by adding a small amount of stereo reverb to the binaural signal in such a way that binaural spaceation is not disrupted.

FIG. 6 shows a configuration in which the external signal generating device drives the in-ear audio coupling without input from the hearing aid electronics. The audio mixing and enhancement (Life Studio) works solely with the audio program material from the external device as well as with ambient sound detected by a microphone or microphones integrated into the external audio signal generating device.

An example of this configuration would be a smart phone that supplies MP3 audio or telephone audio and also picks put ambient sound with its microphone. The audio mixing and enhancement module (Life Studio) may be a software application running on the smart phone, which blends these signals enhances them and sends them to the in-ear audio coupling.

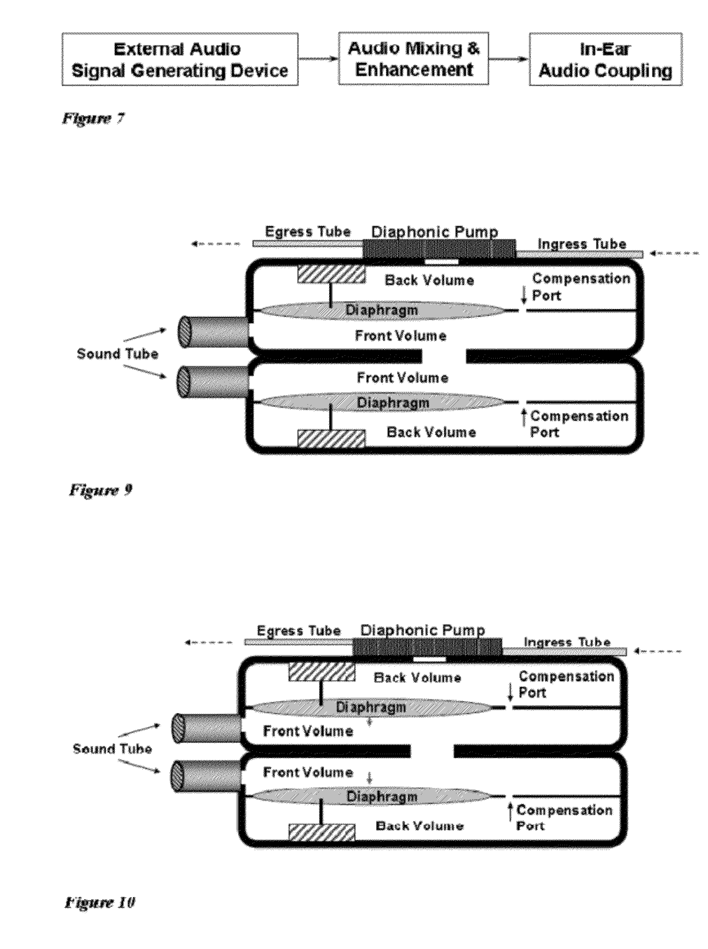

FIG. 7 shows an evolution of FIG. 6 in which the hearing aid electronics are dropped.

An example of this would be an in-ear audio coupling such as an ear mould, or an ADEL with a universal jack, that plugs directly into a smart phone. No hearing aid body or hearing aid electronics are required. The hearing aid function is taken over by the smart phone which has its own microphone and its own signal processing capability. A software application running on the smart phone amplifies and enhances the external sound, performing the function of the hearing aid electronics. Software on the smart phone also mixes the ambient sound with audio program material generated by the smart phone. The resulting signal is sent directly to the in-ear audio coupling.

The configuration of FIG. 7 enables an inexpensive hearing aid. If a user already owns a smart phone, they simply need to purchase an in-ear audio coupling device such as the ADEL. (The inflatable, one size fits all ADEL will be much cheaper than a custom ear mold). They can then plug this coupling device directly into their phone and down load applications to their phone to operate and customize the response of their hearing aid.

When fitting a conventional hearing aid, an audiologist performs a hearing test in which an individual is asked to listen to tones over a range of frequencies and amplitudes (loudnesses). This test produces an audiogram, a plot of the person's hearing response as a function of frequency. An application on the smart phone allows a person to perform the same test on themselves and adjust their hearing aid “app” accordingly. As an example, this can be done by having the smart phone application play a series of tones at different frequencies with the amplitude controlled by a slider bar on the phone's touch screen. For each tone the user slides the bar up to the point where the tone is just barely audible. This procedure determines the user's hearing loss as a function of frequency and is then used by the “hearing aid app” on the smart phone to amplify ambient sound in a way that compensates for the user's frequency specific hearing loss.

In addition to being inexpensive the smart phone based hearing aid is indistinguishable from a smart phone or music player without the hearing aid function. Wearing such a device does not single one out as handicapped. The ADEL is an affordable and high quality audio coupling for the ear. It has applications in consumer audio and communications totally apart from hearing aids. A person could be using an ADEL as their preferred mode of coupling their smart phone to their ears for listing to music and for telecommunications. If this same person then develops a hearing loss, they can simply download the hearing aid application to their phone and they have instantly added hearing aid functionality to the other functions of their device.

“Life Studio”: A Personal Recording Studio Experience

In an embodiment, an apparatus is provided that allows an individual or group of individuals to create a sound production facilitated using many of the recording techniques common to recording studio type productions. Such techniques typically involve, direct or acoustic recording of voice and musical instruments, production mix monitoring and spatial and dynamic range effects. As the creation of such productions typically require the use of dedicated recording studios and processing equipment, the inventive apparatus can be worn by an individual or groups of individuals to produce recorded programs with similar results in more environments and for lower production costs. The system also allows the use of binaural microphone and monitoring techniques so that productions may sound more like real-world recordings as understood by the documented attributes of binaural hearing.

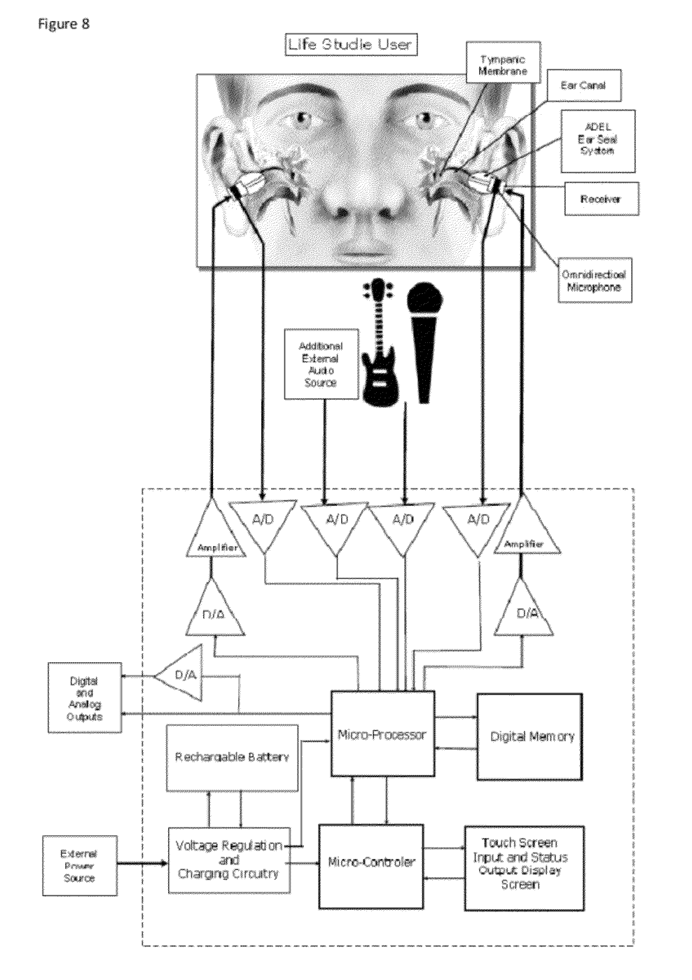

One embodiment of the inventive device is shown in FIG. 8. Primary elements of the device are an in-ear listening and binaural microphone system, and a portable processor/controller unit that connects to the in-ear listening and binaural microphone system. This system is portable and may be made free of any external power system by means of battery power. The In-Ear system consists of an ADEL enabled coupling of a receiver to the ear canal and an omni-directional microphone located near or at the entrance to an individual's ear canal entrance. The processor/controller unit allows one or more individuals to capture acoustic and direct sounds by means of external transducers, other recordings, and binaural means and store them in digital memory. These recordings may be initially or further processed with spatial and dynamic range effects as controlled by the user by means of the Touch Screen Input and Status Display Screen. Since these operations can be additive, well established recording operations may be used to produce and store a final mix. Examples of mixing and processing effects available with Life Studio include reverb, stereo reverb, stereo equalization, left-right balance, left-right input panning, and output in various audio and video formats including compressed formats. All aspects of Life Studio disclosed herein are applicable regardless of whether Life Studio is experience through headphones (headsets) such as an ADEL headset, or through a hearing aid, including a hearing aid with ADEL ear tips.

Life Studio may take voice activated commands from the user and my respond with pre-recorded audio instructions such as: “Take one,” “Once more with feeling,” “That's a wrap,” and the like.

Sound Actuated Pumping Using Sound from Two Transducers

Embodiments have been described in previous patent applications (i.e., the incorporated references), which use a source of sound to drive the inflation of a bubble in a listener's ear. In some embodiments the source of sound has been a balanced armature transducer of the type used in receiver in canal (RIC) type hearing aids, and other in-ear audio devices. Sound pressure in either the front volume or the back volume of the transducer is used to drive a diaphonic valve (diaphonic pump), an inventive device of Asius technologies, which has been previously described in the incorporated references. The Diaphonic valve (diaphonic pump) is then the device that draws in outside air, pressurizes it and feeds it on toward the bubble to be inflated.

This application discloses an improved design for pumping air using two balanced armature transducers, with their front volume in fluid communication. FIG. 9 shows an example of such a design.

Two balanced armature transducers are joined front-volume-to-front-volume with the two front volumes in fluid communication through matched holes in their outer casings. A diaphonic valve (diaphonic pump) is placed over a hole in the casing of the back volume of one of these two transducers. Details of this placement of a diaphonic valve (diaphonic pump) over a hole in the back volume of a balanced armature transducer have been discussed in detail in the incorporated references. The diaphonic valve uses sound pressure in the back volume of the transducer as the energy source to drive a process in which air is drawn in from outside the system through an ingress tube and is expelled at higher static pressure through the egress tube. The flow of air into and out of the system is indicated with dashed arrows.

When the two transducers in FIG. 9 are run with sound waves 180 degrees out of phase, sound in the front volume is largely cancelled out, thus quieting the tone needed to inflate the bubble in the listener's ear. As indicated by the arrows in FIG. 10, when one of the diaphragms in moves toward its respective front volume the other diaphragm is moving away from its front volume, and vice versa.

The simultaneous motion of the two diaphragms, and the fact that the two front volume are in fluid communication, results in the air in the front volumes being pushed and pulled back and forth through the hole between the two front volume, without being compressed or rarified as much as would occur in the front volume of a normal balanced armature transducer. The air in the front volume becomes a sort of “piston” which the two diaphragms cooperatively push one direction and then the other. This cooperative motion of the diaphragms results in less sound being produced in the front volume, because compressions and rarefactions of the air are less. This is an alternative way of looking at the destructive interference of the two 180 degree out of phase sound waves produced by the two diaphragms.

The fact that the transducers are not putting much energy into compressing air in the front volume (i.e. producing less sound) means that more of the power fed to the device is available for pumping air through interaction of the diaphonic valve (diaphonic pump) with the transducer back volume. Another way of looking at the operation of this device is that the two diaphragms are partially coupled together mechanically by the fluid (air) between them, which is continuous because of the hole connecting the two front volume. These two partially coupled diaphragms work cooperatively to compress and rarify the air in the two back volumes. This results in a greater amount of sound energy being generated in the back volumes than would be possible if the two transducers were operating separately.

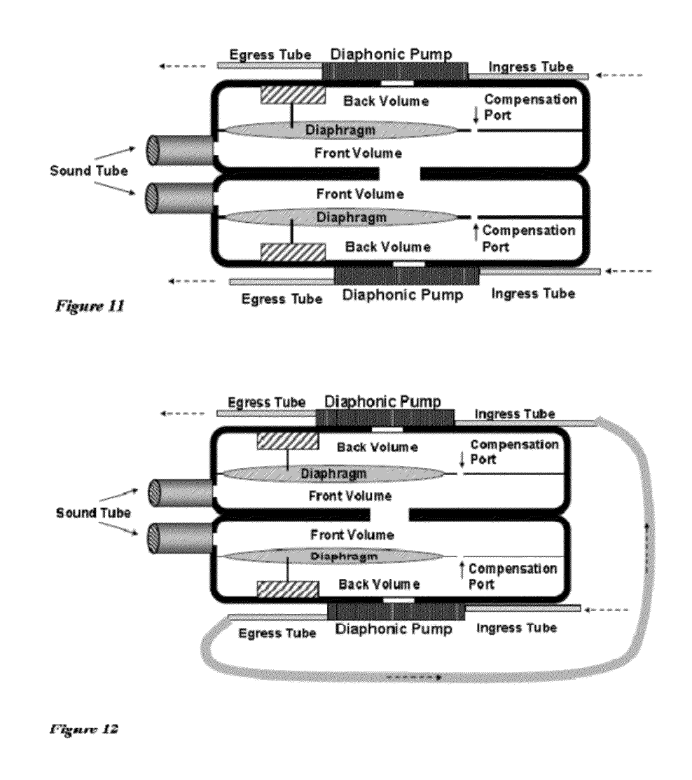

Greater pumping capacity and efficiency can be achieved by adding a second diaphonic pump (diaphonic valve) to the back volume of the second transducer, as shown in FIG. 11.

FIG. 11 shows an embodiment in which the two diaphonic pumps (diaphonic valves) act in parallel. This approach can produce greater flow rates of air.

A series arrangement of the two diaphonic pumps (diaphonic valves), as shown in FIG. 12, can be used to produce higher static air pressures.

In the embodiment of FIG. 12, the egress of the first diaphonic valve is feed into the ingress of the second diaphonic valve. Working prototypes of the device in FIG. 4 have produced static air pressures of greater than 10 kPa and up to 12 kPa, at the time of this filing. Even greater static pressures may be possible with this design.

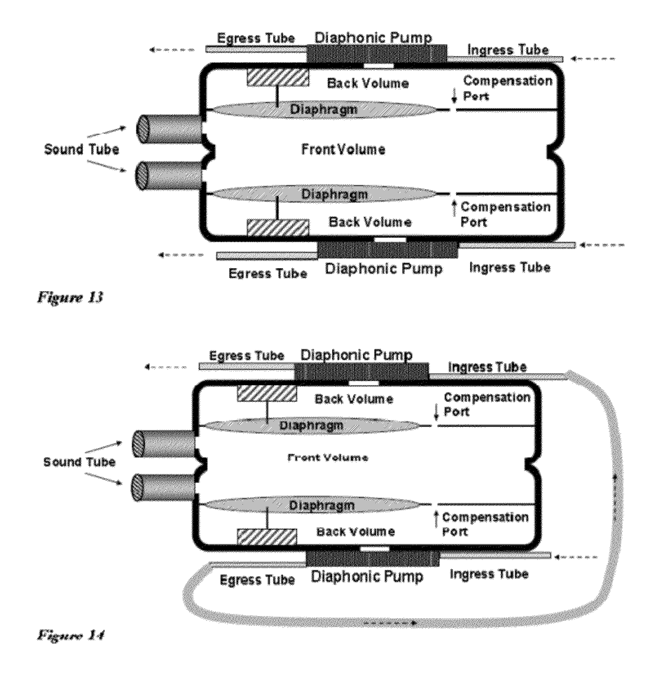

The coupling of the two diaphragms and the sound cancellation in front volume is enhanced by making the hole connecting the two front volumes larger. FIG. 13 shows an example of the embodiment of FIG. 11 in which the connection between the two front volumes is so large that these front volumes are essentially merged into one. Similarly FIG. 14 shows an example of the embodiment of FIG. 12 in which the two front volumes are essentially merged into one.

In all the embodiments shown in FIGS. 1-6, the sound tubes may be open or they may be blocked off or absent to further prevent sound from escaping the front volumes of the transducers.

The connected front volumes of the two transducers may be filled with a fluid substance other than air such as another gas, or a liquid such as water, oil, an organic solvent, a solution in water, a solution in an organic solvent. Filling this space with an impressible liquid will enhance the mechanical coupling of the two diaphragms, possibly increasing the pumping efficiency of the device.

In all the embodiments shown in FIGS. 9-14, the components labeled diaphonic valve (diaphonic pump) may be the multilayered structures produced by laser cutting of and stacking of arrays of chip-like structures on plastic sheets, as described in the incorporated references. This individual chip-like structures may, in fact, house multiple diaphonic valves (diaphonic pumps), which are arranged in series, or in parallel, or in some combination of series and parallel, with respect to one another.

Active Hearing Protection Using ADEL

Because the ADEL bubble in-the-ear device can produce a variable level of isolation from outside ambient noise, due to variation in the pressure inside the bubble, it is ideal of a variable or active hearing protection system. Such an active hearing protection system is useful in environments in which people may need to be speaking with each other or listening to instructions or other audio cues, but may also be unexpectedly subjected to dangerously loud noises. Examples of such environments are a factory production floor, or an airport tarmac.

When the in-ear bubbles of the ADEL device are inflated to relatively high pressure an excellent degree of isolation from outside sounds can be achieved, equal to, or better than, that available from commercial noise canceling headphones. As the pressure in the bubble is lowered the amount of noise isolation is reduced, and when the bubbles are largely or fully deflated, the wearer can hear normally.

An embodiment is disclosed in which the detection of a preset sound pressure level, which is deemed dangerous, by microphones or other sensors integrated into the device, triggers the ADEL bubbles to inflate, thereby protecting the wearer's hearing. The sensors that detect the sound amplitude may be outside the listeners ear or they may be inside the ear canal. Sensors inside the ear canal may be either beyond the point where an inflated ADEL bubble seals the ear canal or they may be outside this sealing point, but still inside the ear canal.

A more refined embodiment is also disclosed in which the ADEL bubble pressure, and the degree of isolation from outside sounds, is progressively adjusted to block out more and more outside sound as the outside noise increases in sound pressure level.

This adjustable, or active hearing protection system uses the same ADEL bubbles and air pumping systems based on speakers or transducers and diaphonic valves (diaphonic pumps), that have been disclosed in this filing and in the incorporated references.

Multiple-Point-of-View Binaural Listening, Recording & Playback

Binaural recording of audio seeks to capture and record sound as experienced by humans in natural hearing. That is, the two ears, by virtue of their separate locations and orientations detect sounds differently as a function of the location of those sounds. This aspect of natural human hearing, provides people with a real world sense of distance and location for the sound they hear. This is somewhat akin to the binocular vision that gives human sight a three dimensional sense of depth perception. Binaural recording uses at least two separate microphones, in separate locations. Often two microphones are placed at the location of the ears on an anatomically accurate dummy head. Also microphones may be worn on the ears of a live listener; one on each ear to record the binaural listening experience.

Playback of binaural recordings utilizes headphones. Each of the listener's ears is fed a separate recording from the appropriate microphone used in the binaural recording. This replicates the natural listening experience, and recreates the directional and depth perception present in the original sound.

Here we disclose the invention of multiple-point-of-view, binaural listening, recording and playback. This technology pertains to the listening, recording and audio reproduction of music, live music performances, sound tracks for video, sound for video games, sound for television, sound for recorded or broadcast sporting events, sound for live or recorded theater, and the like. Multiple binaural microphones are set up at a performance or event and produce simultaneous audio feeds, which provide a listener with different perspectives on the performance or event. A listener in the audience of this performance or event, with headphones and access to the different, simultaneous binaural audio streams can pick the perspective from which he wishes to hear the performance or event. This listener can also switch among the different audio perspectives instantly and in real time.

The separate binaural audio streams, representing different listing locations or perspectives may also be recorded. These multiple recordings of the same event or performance are packaged together on appropriate recording media such that on play-back, the listener can switch between binaural recordings representing different hearing locations or points of view. This multiple binaural recording and playback of sound may or may not be accompanied by simultaneous recording and playback of video or videos (also possibly from different perspectives) of the event or performance.

As an example take a live performance by a musical group. Each performer in the group is fitted with binaural microphones on their ears and binaural dummy heads fitted with microphones are placed at different audience locations (front row, balcony, etc.). Members of the audience are wearing headphones and they can plug into binaural audio streams coming from any one of the sets of binaural microphones at the performance. For instance, a listener in the audience may want to hear the performance from the point of view of the lead singer. Then the listener might want to switch to hear what the drummer is hearing, in real time. Then the listener, who does not necessarily have a good seat at the performance, can switch to another channel and hear the sound in the middle of the front row. This live experience can be recorded by recording all the different binaural audio tracks, possibly also with accompanying video(s). Upon play back, the listener, can again chose in real time to listen to the performance from a range of different perspectives.

The example given for a musical performance can also be logically extended to sporting events, in which different players, officials, coaches, and locations in the venue are wired with binaural microphones for real-time audience listening and/or for broadcast, recording, and subsequent playback. One can watch a football game, in person or on television, live or recorded, and switch between different binaural audio points of view in real time. Multiple point of view audio can also be applied to video games, where the player can choose between different binaural audio points of view from which to interact with the game-action.

Multiple view point recording and playback is a natural application for the Life Studio (personal, portable recording studio) technology previously disclosed in this application. Life Studio may be applied to this application with or without the use of simultaneous video.

Transduction Microphones

In music, but perhaps more so in sports, video and gaming, it is important to record and reproduce the feeling of low frequency vibrations and impacts on the body. This is important to realistically reproduce impacts in sports or in games as well as explosions in movies or in games. The ADEL in-ear device, previously disclosed in the incorporated references, provides excellent transduction of sound into the soft and boney structures of the ear canal and head giving excellent low frequency reproduction of sound and potentially providing excellent “feel” associated with audio of impacts, explosions and the like. However, one still has the problem of accurately recording the “feel” of these impacts, explosions and low frequency noises.

To accomplish this, we disclose a transduction microphone based on a modification of the ADEL in-ear bubble. An ADEL device is inserted in a listener's ear or in the ear of an anatomical, binaural dummy-head. This ADEL bubble contains a microphone inside the bubble. Low frequency sound or impact forces transduced through the head are transferred to the ADEL bubble through contact with the ear canal walls. These sounds or impact forces are then detected by the microphone in the ADEL bubble. A compliment of two of these ADEL based transduction microphones, one in each ear of a person or a dummy head, provides a route to binaural detection and recording of low frequency sounds, impacts and vibrations that faithfully represents how they “feel.” This feel can then be replayed as part of a video, a game, a video of a sporting event, or the like, through the use of headphones with good bone conduction or ear canal conduction characteristics. The ADEL in-ear head phone is an example of such a device.

It should be emphasized that the above-described embodiments of the present invention are possible examples of implementations merely set forth for a clear understanding of the principles of the invention(s). Many variations and modifications may be made to the above-described embodiment(s) of the invention without substantially departing from the spirit and principles of the inventions. All such modifications are intended to be included herein within the scope of this disclosure and the present invention.

What is claimed is:

1. A system comprising:
an in-ear audio coupling device;
hearing aid electronics coupled to the in-ear-audio coupling device;
an external audio signal generating device coupled to the hearing aid electronics; and,
a module operatively coupled to the hearing aid electronics for audio mixing and enhancement.

2. An apparatus comprising:
a first diaphragm having an output; and,
a second diaphragm having an output connected to the output of the first diaphragm.
